(19) United States
(12) Patent Application Publication
(10) Pub. No.: US 2026/0211288 A1
(43) Pub. Date: Jul. 23, 2026

(54) DISPLAY SUBSTRATE, DISPLAY DEVICE, AND MANUFACTURING METHOD FOR DISPLAY SUBSTRATE

(71) Applicant: Sharp Kabushiki Kaisha, Sakai City (JP)

(72) Inventor: Seiji KANEKO, Sakai City (JP)

(21) Appl. No.: 19/451,330

(22) Filed: Jan. 16, 2026

(30) Foreign Application Priority Data
Jan. 22, 2025 (JP) 2025-008981

(51) Int. Cl. G02F 1/1362; G02F 1/1335; G02F 1/1343

(52) U.S. Cl. CPC G02F 1/136209; G02F 1/133526; G02F 1/13439

(57) ABSTRACT

A display substrate includes a transparent substrate having a light-transmitting property, a first insulating film disposed on the transparent substrate, a second insulating film disposed on the first insulating film and having a refractive index different from that of the first insulating film, and a pixel electrode, in which the first insulating film and the second insulating film are provided with a first opening overlapping at least a part of the pixel electrode, and an opening edge of the first opening is configured to be along a normal line with respect to a main surface of the transparent substrate.

### CROSS-REFERENCE TO RELATED APPLICATIONS

This application claims the benefit of priority to Japanese Patent Application Number 2025-008981 filed on Jan. 22, 2025. The entire contents of the above-identified application are hereby incorporated by reference.

### BACKGROUND

### Technical Field

The technology disclosed in the present specification relates to a display substrate in which reflection of light at an opening edge of a first opening is curbed, a display device, and a manufacturing method for the display substrate.

In the related art, one example of a display device and a substrate (display substrate) provided in the display device is known as disclosed in JP 2001-242803 A. The display device disclosed in JP 2001-242803 A has pixels arrayed in a matrix shape on a transparent substrate 1. Each pixel has an opening region in which an electro-optical element for emitting light through the substrate is formed, and a non-opening region in which a thin film transistor TFT for driving the electro-optical element is formed. The non-opening region has a first film composition including the thin film transistor TFT. The opening region has a second film composition extending from the first film composition and interposed between the electro-optic element and the substrate. The second film composition is changed from the first film composition to adjust light passing through the opening region.

### SUMMARY

In the display device disclosed in JP 2001-242803 A, the first film composition on the non-opening region side includes a silicon nitride film having a refractive index different from that of glass of the substrate, whereas the second film composition on the opening region side does not include the silicon nitride film. That is, in the opening region, an opening communicating with a gate insulating film and an interlayer insulating film is provided. However, an opening edge of an opening in the gate insulating film and the interlayer insulating film has a tapered shape inclined with respect to the normal line of the substrate. For this reason, the opening edge of the opening in the gate insulating film and the interlayer insulating film is exposed to the opening region. Since light from a backlight is reflected at an interface of the opening edge exposed to the opening region, there is a problem in that the amount of transmitted light in the opening region is reduced. Since external light is reflected by a tapered end face of the opening edge exposed to the opening region, there is a problem in that display quality is deteriorated.

The technology disclosed in the present specification was completed based on the above circumstances, and an object thereof is to curb reflection of light at the opening edge of the first opening.
(1) A display substrate according to the technology described in the present specification includes a transparent substrate having a light-transmitting property, a first insulating film disposed on the transparent substrate, a second insulating film disposed on the first insulating film and having a refractive index different from a refractive index of the first insulating film, and a pixel electrode, in which the first insulating film and the second insulating film are provided with a first opening overlapping at least a part of the pixel electrode, and an opening edge of the first opening is configured to be along a normal line with respect to a main surface of the transparent substrate.
(2) In addition to the above (1), the display substrate may further include a third insulating film disposed above the transparent substrate and below the first insulating film, in which the first opening is continuously provided in the third insulating film.
(3) In addition to the above (1) or (2), the display substrate may further include a first light blocking portion configured to cover the opening edge of the first opening in the first insulating film and the second insulating film and block light.
(4) In addition to the above (3), the display substrate may further include an electrode configured with a part of a metal film disposed on the second insulating film, in which the first light blocking portion is configured with a part of the metal film.
(5) A display device according to the technology described in the present specification includes the display substrate according to any one of the above (1) to (4), and a counter substrate disposed facing the display substrate.
(6) In addition to the above (5), in the display device, the counter substrate may include a second light blocking portion configured to block light, and the second light blocking portion may include a second opening overlapping at least a part of the pixel electrode and at least a part of the first opening.
(7) A manufacturing method for a display substrate according to the technology described in the present specification includes forming a first insulating film on a transparent substrate, forming a second insulating film on the first insulating film, forming a mask film formed of a semiconductor material or a transparent electrode material on the second insulating film, selectively etching the mask film to provide a third opening, etching the first insulating film and the second insulating film through the third opening of the mask film to provide a first opening in the first insulating film and the second insulating film, the first opening overlapping the third opening of the mask film, and providing a pixel electrode of which at least a part overlaps the first opening.
(8) In addition to the above (7), the manufacturing method for the display substrate may further include forming a semiconductor film on the transparent substrate before forming the first insulating film, selectively etching the semiconductor film to provide a semiconductor portion, selectively etching the mask film to provide a fourth opening overlapping a part of the semiconductor portion together with the third opening, etching the first insulating film and the second insulating film through the third opening and the fourth opening of the mask film to provide a fifth opening in the first insulating film and the second insulating film, the fifth opening overlapping the fourth opening of the mask film together with the first opening, etching the first insulating film and the second insulating film and then supplying a cleaning agent containing hydrofluoric acid onto the mask film to clean, through the fifth opening, a portion of the semiconductor portion which faces the fifth opening and remove the mask film.
(9) In addition to the above (7) or (8), the manufacturing method for the display substrate may further include wet-etching the mask film to provide the third opening, and dry-etching the first insulating film and the second insulating film through the third opening of the mask film to provide the first opening.
(10) In addition to any one of the above (7) to (9), the manufacturing method for the display substrate may further include forming a third insulating film before forming the first insulating film on the transparent substrate, and etching the third insulating film in addition to the first insulating film and the second insulating film through the third opening of the mask film such that the first opening is provided continuously over the first insulating film, the second insulating film, and the third insulating film.
(11) In addition to any one of the above (7) to (10), the manufacturing method for the display substrate may further include forming a metal film on the second insulating film after providing the first opening in the first insulating film and the second insulating film, and selectively etching the metal film to provide a first light blocking portion covering the opening edge of the first opening.
(12) In addition to the above (11), the manufacturing method for the display substrate may further include selectively etching the metal film to provide an electrode together with the first light blocking portion.

According to the technology disclosed in the present specification, it is possible to curb reflection of light at an opening edge of an opening.

### BRIEF DESCRIPTION OF DRAWINGS

The disclosure will be described with reference to the accompanying drawings, wherein like numbers reference like elements.

FIG. 1 is a plan view of a liquid crystal panel, a driver, and a flexible substrate that configure a liquid crystal display device according to a first embodiment.

FIG. 2 is a cross-sectional view of the liquid crystal panel, the driver, and the flexible substrate according to the first embodiment.

FIG. 3 is a circuit diagram illustrating an electrical configuration of an array substrate that configures the liquid crystal panel according to the first embodiment.

FIG. 4 is a plan view illustrating a pixel array of an array substrate according to the first embodiment.

FIG. 5 is a cross-sectional view of the liquid crystal panel according to the first embodiment which is taken along line v-v in FIG. 4.

FIG. 6 is a cross-sectional view of the liquid crystal panel according to the first embodiment which is taken along line vi-vi in FIG. 4.

FIG. 7 is a cross-sectional view of the liquid crystal panel according to the first embodiment which is taken along a line vii-vii in FIG. 4.

FIG. 8 is a cross-sectional view similar to FIG. 5, illustrating a state where a first interlayer insulating film, a second interlayer insulating film, a mask film, and a first photoresist film have been formed in a fifth step after first to fourth steps included in an array substrate manufacturing step according to the first embodiment.

FIG. 9 is a cross-sectional view similar to FIG. 5, illustrating a state where the first photoresist film has been exposed and developed in the fifth step included in the array substrate manufacturing step according to the first embodiment.

FIG. 10 is a cross-sectional view similar to FIG. 5, illustrating a state where the mask film has been wet-etched in the fifth step included in the array substrate manufacturing step according to the first embodiment.

FIG. 11 is a cross-sectional view similar to FIG. 5, illustrating a state where the first interlayer insulating film and the second interlayer insulating film have been dry-etched in the fifth step included in the array substrate manufacturing step according to the first embodiment.

FIG. 12 is a cross-sectional view similar to FIG. 5, illustrating a state where a cleaning liquid has been supplied and the mask film has been removed in a sixth step included in the array substrate manufacturing step according to the first embodiment.

FIG. 13 is a cross-sectional view similar to FIG. 5, illustrating a state where a second metal film and a second photoresist film have been formed, and then the second photoresist film has been exposed and developed in a seventh step included in the array substrate manufacturing step according to the first embodiment.

FIG. 14 is a cross-sectional view similar to FIG. 5, illustrating a state where the second metal film has been etched in the seventh step included in the array substrate manufacturing step according to the first embodiment.

FIG. 15 is a cross-sectional view similar to FIG. 5 in a liquid crystal panel according to a second embodiment.

FIG. 16 is a cross-sectional view similar to FIG. 6 in the liquid crystal panel according to the second embodiment.

FIG. 17 is a cross-sectional view similar to FIG. 7 in the liquid crystal panel according to the second embodiment.

FIG. 18 is a cross-sectional view similar to FIG. 5, illustrating a state after a second metal film and a second photoresist film have been formed in a seventh step included in an array substrate manufacturing step according to the second embodiment, and the second photoresist film has been exposed and developed.

FIG. 19 is a cross-sectional view similar to FIG. 5, illustrating a state after the second metal film has been etched in the seventh step included in the array substrate manufacturing step according to the second embodiment.

### DESCRIPTION OF EMBODIMENTS

First Embodiment

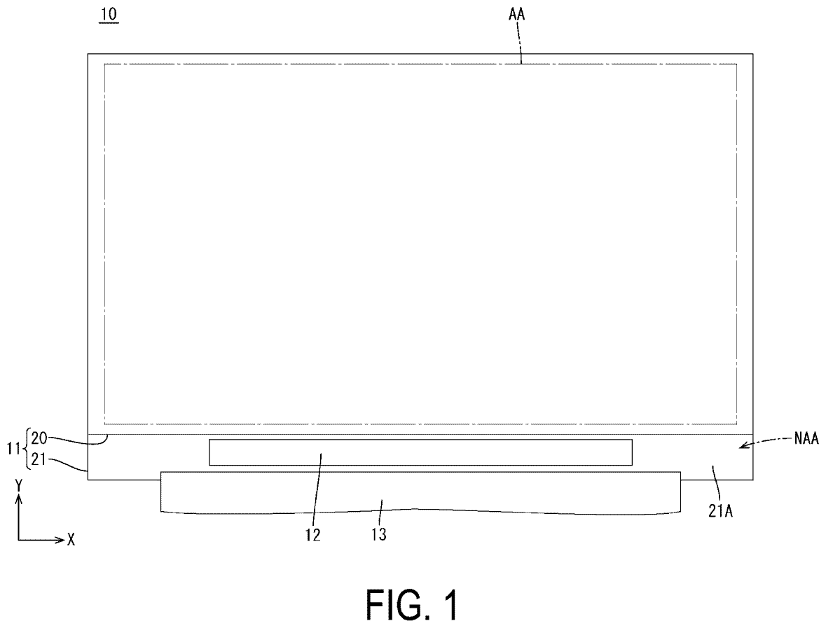

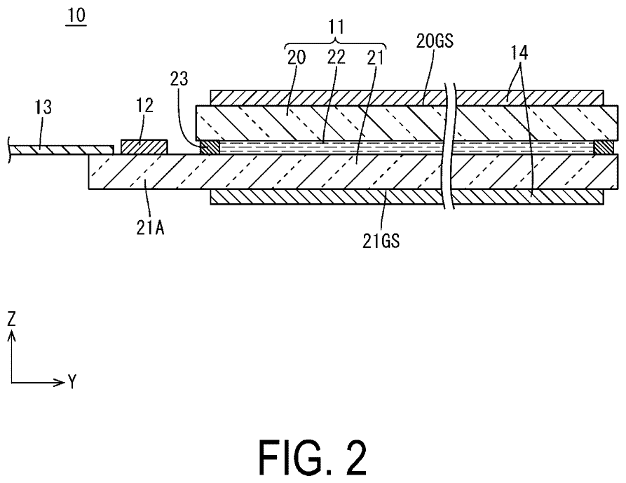

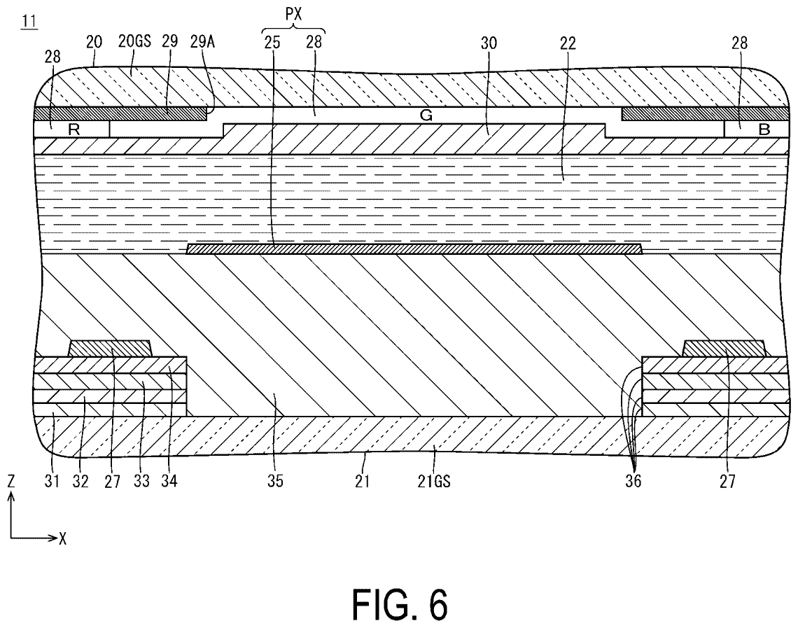

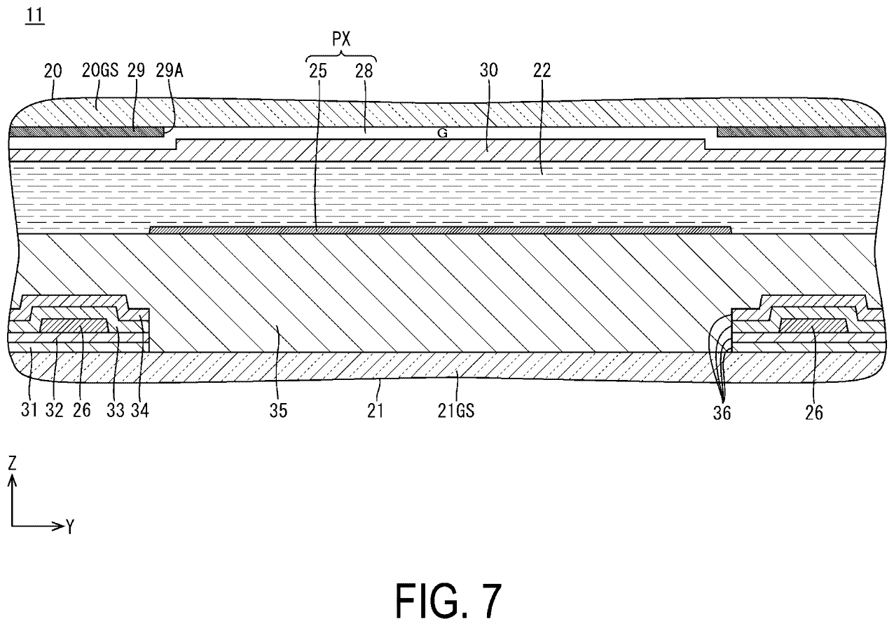

A first embodiment will be described with reference to FIG. 1 to FIG. 14. In the present embodiment, a liquid crystal display device 10 is exemplified. Some drawings illustrate an X-axis, a Y-axis, and a Z-axis, and directions of these axes are drawn such that the directions correspond to those indicated in the drawings individually. An upper side in each of FIG. 2 and FIGS. 5 to 14 is referred to as a front side, and a lower side in each of the drawings is referred to as a rear side.

As illustrated in FIG. 1, the liquid crystal display device 10 includes at least a liquid crystal panel (display device, display panel) 11 that has a horizontally elongated rectangular shape and is capable of displaying an image, and a backlight device (illumination device) that irradiates the liquid crystal panel 11 with light for use in display. The backlight device includes a light source (for example, an LED or the like) disposed on a rear side (back face side) of the liquid crystal panel 11 and configured to emit light having a white color, an optical member configured to impart an optical effect on the light from the light source, thereby converting the light into planar light, and the like. A center-side portion of a main surface of the liquid crystal panel 11 is a display region AA in which an image is displayed. On the other hand, a frame-shaped outer peripheral portion surrounding the display region AA of the main surface of the liquid crystal panel 11 is a non-display region NAA in which no image is displayed.

The liquid crystal panel 11 will be described with reference to FIG. 2 in addition to FIG. 1. As illustrated in FIGS. 1 and 2, the liquid crystal panel 11 is formed by bonding a pair of substrates 20 and 21 together. In the pair of substrates 20 and 21, the front side is a counter substrate 20, and the rear side is an array substrate (display substrate) 21. The counter substrate 20 and the array substrate 21 are both formed by layering various films on the inner face sides of glass substrates (transparent substrates) 20GS and 21GS having a light-transmitting property. A liquid crystal layer 22 is interposed between the pair of substrates 20 and 21 and contains liquid crystal molecules, which are materials having optical characteristics that change in accordance with application of an electrical field. A sealing portion 23 that seals the liquid crystal layer 22 is provided to be interposed between outer peripheral ends of the pair of substrates 20 and 21. The sealing portion 23 is formed in a rectangular frame-like shape to surround the liquid crystal layer 22. Note that polarizers 14 are bonded to outer face sides of both the substrates 20 and 21, respectively.

As illustrated in FIG. 1 and FIG. 2, the counter substrate 20 has a short side dimension shorter than a short side dimension of the array substrate 21. The counter substrate 20 is bonded to the array substrate 21 with one end in a short side direction (Y-axis direction) aligned with the array substrate 21. Thus, the other end of the array substrate 21 in the short side direction is an exposed portion 21A that protrudes laterally relative to the counter substrate 20 and is exposed. An overall region of the exposed portion 21A is a non-display region NAA, in which a driver 12 for supplying various signals and a flexible substrate 13 are mounted.

The driver 12 includes an LSI chip having a drive circuit therein. The driver 12 is mounted on the exposed portion 21A of the array substrate 21 in a chip-on-glass (COG) manner. The driver 12 processes various signals transmitted by the flexible substrate 13. As illustrated in FIG. 1 and FIG. 2, the driver 12 is adjacent to one side of the display region AA in the Y-axis direction, and is sandwiched between the flexible substrate 13 to be described below and the display region AA. The driver 12 has a horizontally elongated rectangular planar shape. The driver 12 can supply various signals to a source wiring line 27 and the like provided on the array substrate 21. The flexible substrate 13 has a configuration in which a large number of wiring line patterns are formed on a base material formed of a synthetic resin material (for example, a polyimide resin or the like) having insulating properties and flexibility. One end of the flexible substrate 13 is connected to the exposed portion 21A of the array substrate 21, and the other end is connected to an external circuit substrate (a control substrate or the like).

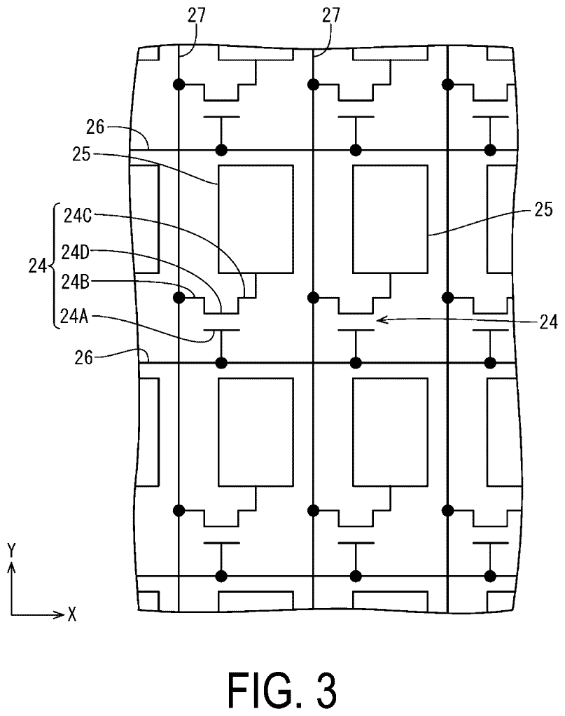

Next, a configuration of the display region AA in the array substrate 21 will be described with reference to FIG. 3. As illustrated in FIG. 3, at least a TFT (thin film transistor, switching element) 24 and a pixel electrode 25 are provided on an inner face side of the display region AA of the array substrate 21. A plurality of the TFTs 24 and a plurality of the pixel electrodes 25 are provided in a matrix shape at intervals therebetween along the X-axis direction and the Y-axis direction. Gate wiring lines (scanning wiring lines) 26 and source wiring lines (image wiring lines, signal wiring lines) 27 orthogonal to (intersecting) each other are disposed around the TFTs 24 and the pixel electrodes 25. The gate wiring lines 26 extend along the X-axis direction and a plurality of the gate wiring lines 26 are disposed at intervals in the Y-axis direction. The source wiring lines 27 extend along the Y-axis direction and a plurality of the source wiring lines 27 are disposed at intervals in the X-axis direction. The TFT 24 includes a gate electrode 24A connected to the gate wiring line 26, a source electrode (electrode) 24B connected to the source wiring line 27, a drain electrode (electrode) 24C connected to the pixel electrode 25, and a semiconductor portion 24D connected to the source electrode 24B and the drain electrode 24C. The TFT 24 is driven on the basis of a scanning signal supplied to the gate electrode 24A by the gate wiring line 26. The scanning signal includes a potential higher than the threshold voltage of the TFT 24. Then, a potential related to an image signal supplied to the source electrode 24B by the source wiring line 27 is supplied to the drain electrode 24C via the semiconductor portion 24D. As a result, the pixel electrode 25 is charged to the potential related to the image signal.

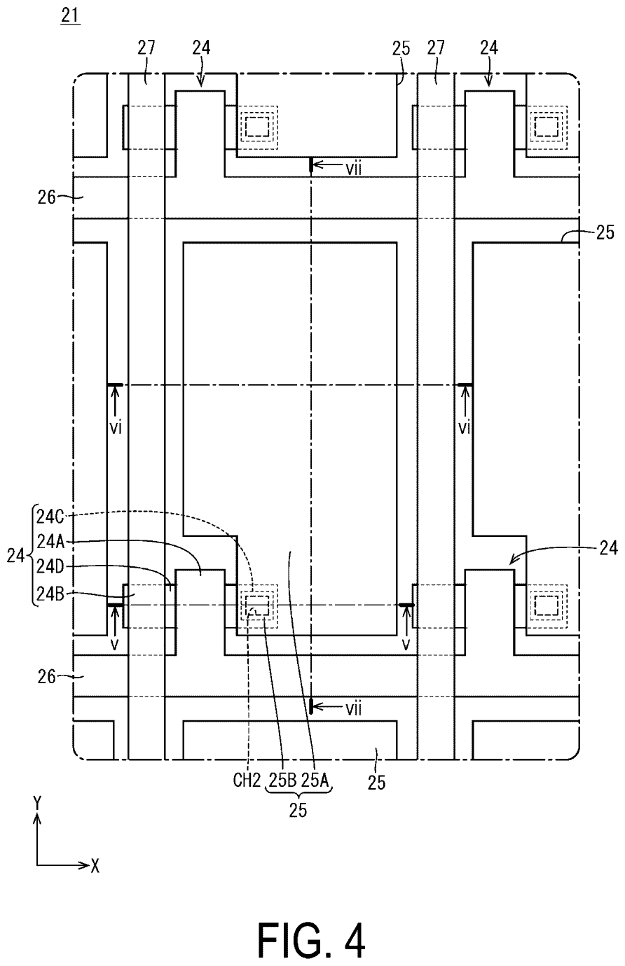

As illustrated in FIG. 4, the TFT 24 is disposed near an intersection between the gate wiring line 26 and the source wiring line 27. The pixel electrode 25 is disposed in a region surrounded by the gate wiring line 26 and the source wiring line 27, and has a planar shape which is, for example, a substantially rectangular shape that is vertically elongated. Specifically, the pixel electrode 25 has a planar shape in which one corner of a vertically elongated rectangle is slightly cut out. Thereby, the pixel electrodes 25 do not overlap the most part of the TFT 24 (including the gate electrode 24A and the source electrode 24B), but overlap a part of the TFT 24 (including the drain electrode 24C). A portion of the pixel electrode 25 which does not overlap the TFT 24 is a main body portion 25A that mainly contributes to display. A portion of the pixel electrode 25 which overlaps the TFT 24 is a connection portion 25B connected to the drain electrode 24C.

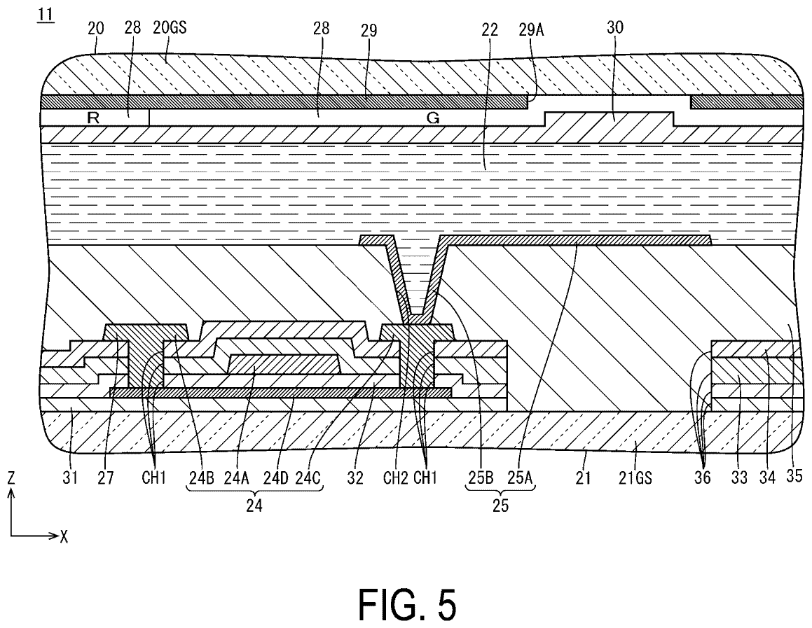

The configuration of the display region AA in the counter substrate 20 that configures the liquid crystal panel 11 will be described using FIG. 5. As illustrated in FIG. 5, the display region AA of the counter substrate 20 is provided with a large number of color filters 28 at positions that overlap the pixel electrodes 25 provided on the array substrate 21. The color filters 28 are arranged in a pattern in which three colors of red (R), green (G), and blue (B) are alternately repeated along the X-axis direction. The color filters 28 of the three colors extend along the Y-axis direction, and are thereby arranged in a substantially stripe shape as a whole. The color filter 28 and the pixel electrode 25 overlapping each other configure a pixel PX which is a display unit. In the liquid crystal panel 11, the color filters 28 of the three colors arranged along the X-axis direction and three pixel electrodes 25 facing the color filters 28 configure three color pixels PX (red pixel, green pixel, and blue pixel). In the liquid crystal panel 11, a display pixel capable of color display with a predetermined gradation is configured by the three color pixels PX adjacent to each other along the X-axis direction.

As illustrated in FIG. 5, the display region AA of the counter substrate 20 is provided with a black matrix (second light blocking portion) 29 that separates (boundaries between) adjacent pixels PX in the X-axis direction and the Y-axis direction. The black matrix 29 is provided in a non-display region NAA in addition to the display region AA. The black matrix 29 is formed in a lattice shape so as to overlap the TFT 24, the gate wiring lines 26, and the source wiring lines 27 in the display region AA, but is formed in a substantially solid state in the non-display region NAA. In the display region AA, the black matrix 29 includes pixel openings (second openings) 29A at positions overlapping the pixels PX (pixel electrodes 25). The number of pixel openings 29A installed and arrangement intervals therebetween are the same as the number of pixels PX installed and the arrangement intervals therebetween. Specifically, the pixel opening 29A is disposed not to overlap the connection portion 25B of the pixel electrodes 25 provided on the array substrate 21 but to overlap the main body portion 25A, and has a size slightly smaller than the main body portion 25A in a plan view. The pixel opening 29A has a size that overlaps most of the main body portion 25A except for the outer peripheral end and does not overlap the outer peripheral end of the main body portion 25A.

As illustrated in FIG. 5, an overcoat film 30 is provided on the side of a layer higher than the color filter 28 and the black matrix 29. The overcoat film 30 is provided in a solid state over substantially the entire region of the counter substrate 20. The overcoat film 30 is formed of an organic material such as an acrylic resin (for example, PMMA), and functions to flatten a step generated on the side of a layer lower than the overcoat film 30. Alignment films (not illustrated) for aligning the liquid crystal molecules included in the liquid crystal layer 22 are respectively formed on innermost faces (uppermost layers) in contact with the liquid crystal layer 22 in both the substrates 20, 21.

Either the counter substrate 20 or the array substrate 21 is provided with a common electrode (not illustrated) formed of the same transparent electrode material as that of the pixel electrode 25 and disposed to overlap the pixel electrode 25 with an interval therebetween. The common electrode extends at least over substantially the entire region of the display region AA, and is disposed to overlap all the pixel electrodes 25 with an interval therebetween. In the liquid crystal panel 11, a predetermined electrical field is applied to the liquid crystal layer 22 on the basis of a potential difference generated between the common electrode and each pixel electrode 25, thereby making it possible to perform predetermined gradation display on each pixel PX.

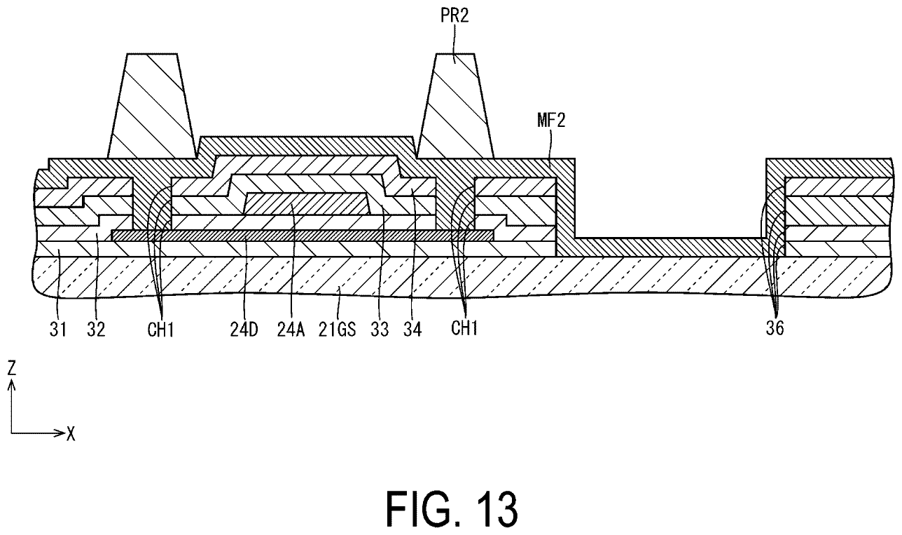

Here, various films layered on the inner face side of the array substrate 21 will be described with reference to FIG. 5. As illustrated in FIG. 5, at least a base coat film (third insulating film) 31, a semiconductor film, a gate insulating film (third insulating film) 32, a first metal film, a first interlayer insulating film (first insulating film) 33, a second interlayer insulating film (second insulating film) 34, a second metal film (metal film) MF2, a flattening film (fourth insulating film) 35, a first transparent electrode film, and an alignment film are layered on the glass substrate 21GS of the array substrate 21 in order from the lower layer side (glass substrate 21GS side). Among these, the second metal film MF2 is illustrated in FIG. 13.

The first metal film and the second metal film MF2 are both single-layer films formed of one type of metal material, or layered films or alloys formed of different types of metal materials, and thus have electrical conductivity. The first metal film configures the gate wiring line 26, the gate electrode 24A of the TFT 24, and the like. The second metal film MF2 configures the source wiring line 27, the source electrode 24B and the drain electrode 24C of the TFT 24, and the like.

The semiconductor film is formed of a polysilicon semiconductor material (semiconductor material) having crystallinity by a known method such as laser crystallization. The polysilicon semiconductor material of the semiconductor film has higher electron mobility than an amorphous silicon semiconductor material and an oxide semiconductor material. The semiconductor film configures the semiconductor portion 24D of the TFT 24, and the like. The first transparent electrode film is formed of a transparent electrode material such as indium tin oxide (ITO), indium zinc oxide (IZO), or the like. The first transparent electrode film configures the pixel electrode 25 and the like.

The base coat film 31, the gate insulating film 32, the first interlayer insulating film 33, and the second interlayer insulating film 34 are each a single-layer film or a layered film formed of an inorganic material (inorganic resin material). Among these, the gate insulating film 32 and the first interlayer insulating film 33 are both single-layer films formed of SiO₂ (silicon oxide) which is a type of inorganic material, and have a refractive index of approximately 1.4 to 1.55. Thus, there is little difference in refractive index between the gate insulating film 32 and the first interlayer insulating film 33. The second interlayer insulating film 34 is a single-layer film formed of SiNₓ (silicon nitride) which is a type of inorganic material, and has a refractive index of approximately 2. Thus, the second interlayer insulating film 34 has a refractive index larger than those of the gate insulating film 32 and the first interlayer insulating film 33. The flattening film 35 is formed of an organic material such as PMMA (acrylic resin). The film thickness of the flattening film 35 is far greater than the film thicknesses of the base coat film 31, the gate insulating film 32, the first interlayer insulating film 33, and the second interlayer insulating film 34. The flattening film 35 flattens the inner face of the array substrate 21 (the surface on the liquid crystal layer 22 side). The base coat film 31 is located on the side of a layer lower than the semiconductor film. The gate insulating film 32 is interposed between the semiconductor film and the first metal film. The first interlayer insulating film 33 and the second interlayer insulating film 34 are interposed between the first metal film and the second metal film MF2. The flattening film 35 is interposed between the second metal film MF2 and the first transparent electrode film.

A detailed configuration of the TFT 24 will be described below. As illustrated in FIG. 5, in the TFT 24, the gate electrode 24A configured with a part of the first metal film is disposed on the side of a layer higher than the semiconductor portion 24D, which is formed of a part of the semiconductor film, with the gate insulating film 32 interposed therebetween. That is, the TFT 24 can be said to be a top-gate type transistor. As illustrated in FIGS. 4 and 5, the semiconductor portion 24D has a horizontally elongated rectangular shape extending along the X-axis direction. The gate electrode 24A is disposed to overlap the central portion of the semiconductor portion 24D in the longitudinal direction (X-axis direction). The source electrode 24B and the drain electrode 24C, each of which is configured with a part of the second metal film MF2, are disposed at positions spaced apart from each other so as to sandwich the gate electrode 24A therebetween in the X-axis direction, and are disposed to overlap both end portions of the semiconductor portion 24D in the longitudinal direction.

As illustrated in FIG. 5, the gate insulating film 32, the first interlayer insulating film 33, and the second interlayer insulating film 34 interposed between the semiconductor portion 24D and the source and drain electrodes 24B and 24C are provided with first pixel contact holes (fifth openings) CH1 that respectively communicate with a position overlapping both the source electrode 24B and the semiconductor portion 24D and a position overlapping both the drain electrode 24C and the semiconductor portion 24D. The source electrode 24B and the semiconductor portion 24D are connected to each other through one of the first pixel contact holes CH1. The drain electrode 24C and the semiconductor portion 24D are connected to each other through the other first pixel contact hole CH1. The connection portion 25B of the pixel electrode 25, which is configured with a part of the first transparent electrode film, is disposed to overlap the drain electrode 24C. The flattening film 35 interposed between the connection portion 25B and the drain electrode 24C is provided with a second pixel contact hole CH2 at a position overlapping both the connection portion 25B and the drain electrode 24C. The connection portion 25B and the drain electrode 24C are connected to each other through the second pixel contact hole CH2. In the present embodiment, the second pixel contact hole CH2 is disposed to overlap the other first pixel contact hole CH1.

The array substrate 21 according to the present embodiment has a configuration in which the first interlayer insulating film 33 and the second interlayer insulating film 34 having a refractive index higher than that of the first interlayer insulating film 33 are layered. For this reason, all light emitted from the backlight device to the liquid crystal panel 11 does not pass through the first interlayer insulating film 33 and the second interlayer insulating film 34, and a part of the light is reflected by the interface between the first interlayer insulating film 33 and the second interlayer insulating film 34. For this reason, there is a concern that the amount of light passing through the main body portion 25A of the pixel electrode 25 and the pixel opening 29A, that is, the amount of light passing through the pixels PX may become insufficient.

In this regard, in the present embodiment, as illustrated in FIGS. 5 to 7, a first opening 36 is provided at a position overlapping at least a part of the pixel electrode 25 in the first interlayer insulating film 33 and the second interlayer insulating film 34. In this manner, light directed toward the pixel electrode 25, of the light emitted from the backlight device to the liquid crystal panel 11, passes through the first opening 36, and is less likely to be reflected by the interface between the first interlayer insulating film 33 and the second interlayer insulating film 34. Thereby, it is possible to secure a sufficient amount of light passing through the pixels PX. The first opening 36 is formed over a range overlapping the main body portion 25A (pixel opening 29A) of the pixel electrode 25, and is disposed not to overlap the connection portion 25B of the pixel electrode 25. Thereby, it is possible to secure a sufficient amount of light passing through the main body portion 25A of the pixel electrodes 25, which contributes to display.

In the present embodiment, in the first interlayer insulating film 33 and the second interlayer insulating film 34, the opening edge of the first opening 36 is configured to be along the normal line with respect to the main surface of the glass substrate 21GS and is parallel to the Z-axis direction, as illustrated in FIGS. 5 to 7. The expression “the opening edge of the first opening 36 is configured to be along the normal line with respect to the main surface of the glass substrate 21GS” includes not only a case where the opening edge of the first opening 36 has a linear shape parallel to the Z-axis direction (perpendicular to the main surface of the glass substrate 21GS) but also a case where the opening edge of the first opening 36 is inclined by, for example, approximately ±5°with respect to the Z-axis direction. In this manner, as compared with a case where an opening edge of an opening in a gate insulating film and an interlayer insulating film has a tapered shape inclined with respect to the normal line of a substrate as in the related art, an overlapping range between the opening edge of the first opening 36 and the pixel electrode 25 is narrowed, or the opening edge of the first opening 36 and the pixel electrode 25 do not overlap each other. In comparison with the related art, a range in which the opening edge of the first opening 36 is exposed to the pixel opening 29A of the black matrix 29 is narrowed or is not exposed. Thereby, light directed toward the pixel electrode 25 is less likely to be reflected by the interface between the portions of the first interlayer insulating film 33 and the second interlayer insulating film 34 which configure the opening edge of the first opening 36, and external light is less likely to be reflected by the end face of the opening edge of the first opening 36. Thus, a larger amount of light can pass through the pixel opening 29A (pixel PX), and unnecessary reflection of external light is curbed, thereby maintaining a good display quality.

In the present embodiment, as illustrated in FIGS. 5 to 7, the first opening 36 is continuously provided in the base coat film 31 and the gate insulating film 32 disposed above the glass substrate 21GS and under the first interlayer insulating film 33. That is, the first opening 36 is provided to penetrate all the insulating films 31 to 34 located on the side of a layer lower than the flattening film 35 in the array substrate 21. The opening edge of the first opening 36 is configured to be along the normal line with respect to the main surface of the glass substrate 21GS over all of the base coat film 31, the gate insulating film 32, the first interlayer insulating film 33, and the second interlayer insulating film 34. Here, when the first opening 36 is not formed in the base coat film 31 and the gate insulating film 32, there is a concern that portions of the base coat film 31 and the gate insulating film 32 which overlap the first opening 36 may be removed by etching when the first opening 36 is provided in the first interlayer insulating film 33 and the second interlayer insulating film 34, and in this case, there is a concern that a variation in film thickness of the portions of the base coat film 31 and the gate insulating film 32 which overlap the first opening 36 occurs, resulting in a concern that unevenness in the amount of transmitted light or color unevenness may occur. In this regard, as in the present embodiment, the first opening 36 is provided over the first interlayer insulating film 33, the second interlayer insulating film 34, the base coat film 31, and the gate insulating film 32, and thus it is possible to avoid the occurrence of unevenness in the amount of transmitted light and color unevenness as described above. Moreover, since the opening edge of the first opening 36 is configured to be along the normal line with respect to the main surface of the glass substrate 21GS, light directed toward the pixel electrodes 25 is less likely to be reflected by the interface between the portions of the first interlayer insulating film 33, the second interlayer insulating film 34, the base coat film 31, and the gate insulating film 32 which configure the opening edge of the first opening 36, and external light is less likely to be reflected by the end face of the opening edge of the first opening 36.

The present embodiment has the above-described structure, and a manufacturing method for the liquid crystal panel 11 will be subsequently described. The manufacturing method for the liquid crystal panel 11 includes a counter substrate manufacturing step of manufacturing the counter substrate 20, an array substrate manufacturing step of manufacturing the array substrate 21, and a bonding step of bonding the manufactured counter substrate 20 and array substrate 21 together. Among these, the array substrate manufacturing step (a manufacturing method for the array substrate 21) will be described below.

The array substrate manufacturing step includes at least a first step of forming the base coat film 31, a second step of depositing and patterning a semiconductor film, a third step of depositing the gate insulating film 32, a fourth step of depositing and patterning the first metal film, a fifth step of depositing and patterning the first interlayer insulating film 33, the second interlayer insulating film 34, and the like, a sixth step of cleaning the semiconductor portion 24D, a seventh step of depositing and patterning the second metal film MF2, an eighth step of depositing and patterning the flattening film 35, and a ninth step of depositing and patterning the first transparent electrode film.

The term “patterning” described above means a process of a film based on a general photolithography method. Specifically, processing, that is, patterning of a film to be processed is performed by performing the film formation of a photoresist film on the film to be processed, exposing the photoresist film with an exposure device through a photomask having a predetermined opening pattern, developing the photoresist film, and performing etching through the developed photoresist film.

In the first step, the base coat film 31 is formed on the glass substrate 21GS (see FIGS. 5 to 7). In the second step, the semiconductor film is formed on the base coat film 31, and the semiconductor film is selectively etched by a photolithography method. Thereby, the semiconductor portion 24D of the TFT 24 is formed (see FIG. 5). In the third step, the gate insulating film 32 is formed on the base coat film 31 and the semiconductor film (see FIGS. 5 to 7). In the fourth step, the first metal film is formed on the gate insulating film 32, and the first metal film is selectively etched by a photolithography method. Thereby, the gate electrode 24A of the TFT 24 and the gate wiring line 26 are formed (see FIGS. 4 and 5).

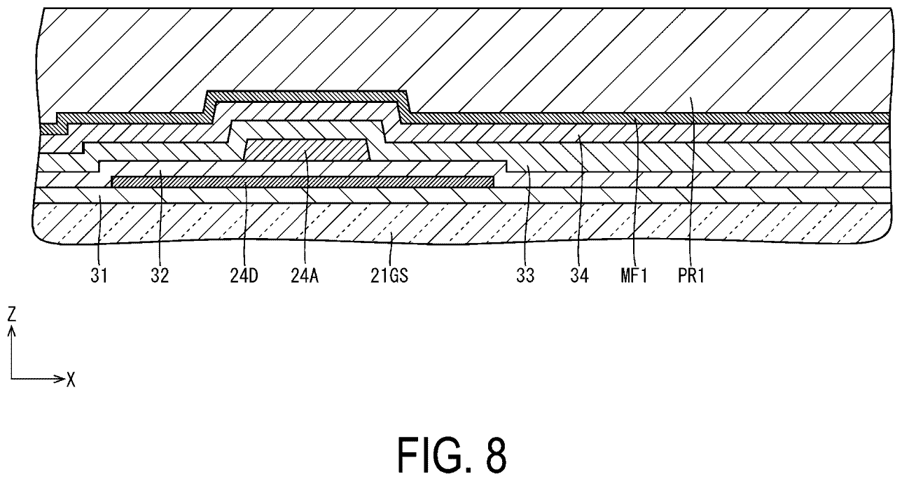

In the fifth step, the first interlayer insulating film 33 is formed on the gate insulating film 32 and the first metal film, and then the second interlayer insulating film 34 is formed on the first interlayer insulating film 33. Then, as illustrated in FIG. 8, a mask film MF1 is formed on the second interlayer insulating film 34, and then a first photoresist film PR1 is formed on the mask film MF1. The first photoresist film PR1 may be either a positive type or a negative type. Here, the mask film MF1 functions as a mask when patterning the first interlayer insulating film 33 and the second interlayer insulating film 34, which will be described in detail later. The mask film MF1 has a film thickness smaller than that of the first photoresist film PR1. Specifically, the film thickness of the first photoresist film PR1 is approximately several micrometers, whereas the film thickness of the mask film MF1 is approximately several tens of nanometers. In the present embodiment, the mask film MF1 is formed of an oxide semiconductor material, which is a type of a semiconductor material. The oxide semiconductor material configuring the mask film MF1 may contain, for example, at least one metal element selected from In, Ga, and Zn, and may be, for example, an In—Ga—Zn—O-based semiconductor (for example, indium gallium zinc oxide). Here, the In—Ga—Zn—O-based semiconductor is a ternary oxide of In (indium), Ga (gallium), and Zn (zinc), there is no particular limitation on a ratio (composition ratio) of In, Ga, and Zn, and examples of the ratio include In:Ga:Zn=2:2:1, In:Ga:Zn=1:1:1, In:Ga:Zn=1:1:2, and the like. The In—Ga—Zn—O-based semiconductor used for the semiconductor film may be amorphous or crystalline. The oxide semiconductor material configuring the mask film MF1 may contain other oxide semiconductors instead of the In—Ga—Zn—O-based semiconductor. There may be included, for example, an In—Sn—Zn—O-based semiconductor (for example, In₂O₃—SnO₂—ZnO; InSnZnO). The In—Sn—Zn—O-based semiconductor is a ternary oxide of In (indium), Sn (tin), and Zn (zinc). Alternatively, the oxide semiconductor layer may include an In—W—Zn—O-based semiconductor and an In—W—Sn—Zn—O-based semiconductor containing tungsten (W), an In—Al—Zn—O-based semiconductor, an In—Al—Sn—Zn—O-based semiconductor, a Zn—O-based semiconductor, an In—Zn—O-based semiconductor, a Zn—Ti—O-based semiconductor, a Cd—Ge—O-based semiconductor, a Cd—Pb—O-based semiconductor, CdO (cadmium oxide), a Mg—Zn—O-based semiconductor, an In—Ga—Sn—O-based semiconductor, an In—Ga—O-based semiconductor, a Zr—In—Zn—O-based semiconductor, a Hf—In—Zn—O-based semiconductor, an Al—Ga—Zn—O-based semiconductor, a Ga—Zn—O-based semiconductor, an In—Ga—Zn—Sn—O-based semiconductor, and the like.

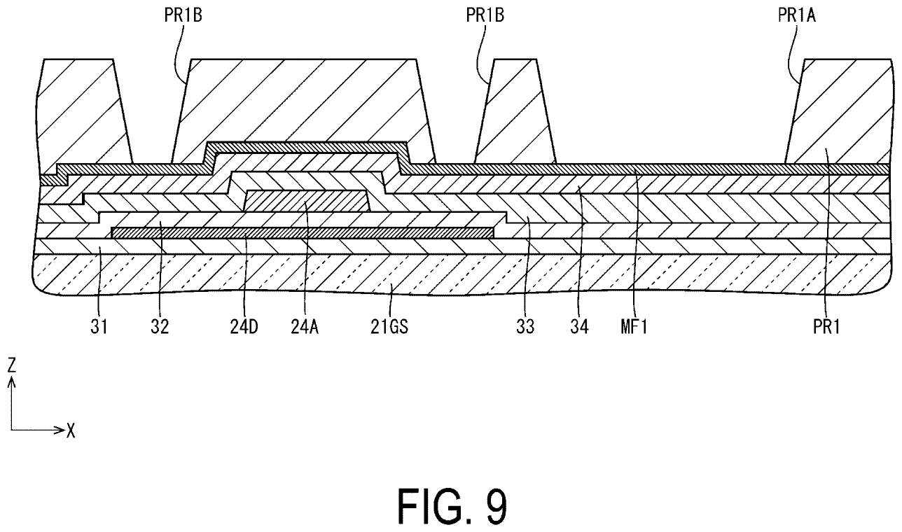

In the fifth step, as illustrated in FIG. 8, after the first interlayer insulating film 33, the second interlayer insulating film 34, the mask film MF1, and the first photoresist film PR1 are sequentially formed as described above, the first photoresist film PR1 is exposed using an exposure device and a photomask having a predetermined opening pattern (the exposure device and the photomask are not illustrated in the drawing), and is then developed. Then, the first photoresist film PR1 remains on the mask film MF1 in a form in which the opening pattern of the photomask is transferred. Specifically, when the first photoresist film PR1 is a positive type, an unexposed portion not overlapping the opening of the photomask remains, and when the first photoresist film PR1 is a negative type, an exposed portion overlapping the opening of the photomask remains. As illustrated in FIG. 9, the remaining first photoresist film PR1 includes a first resist opening PR1A overlapping a position where the first opening 36 is to be formed and a second resist opening PR1B overlapping a position where the first pixel contact hole CH1 is to be formed. The opening edges of the first resist opening PR1A and the second resist opening PR1B in the first photoresist film PR1 are tapered (inclined) with respect to the normal line of the main surface of the glass substrate 21GS.

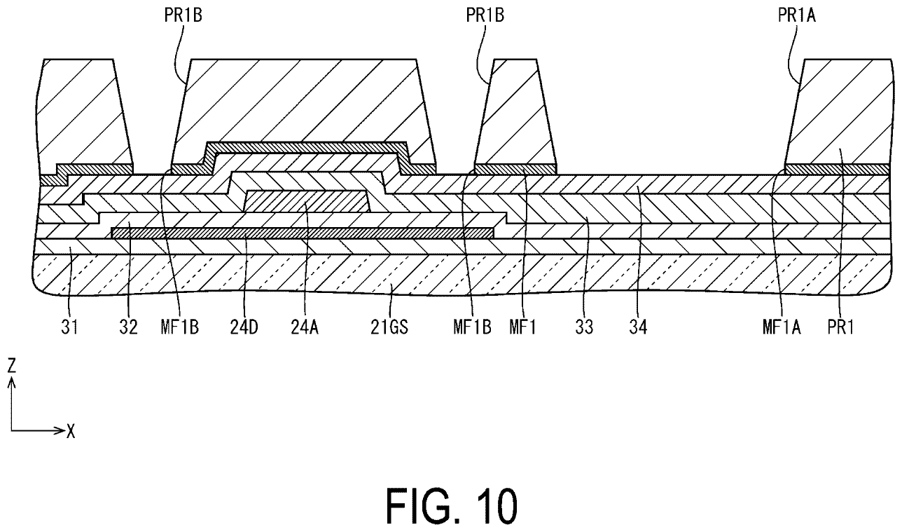

The mask film MF1 is wet-etched using the first photoresist film PR1 having such a configuration as a mask. Then, as illustrated in FIG. 10, a portion of the mask film MF1 which overlaps the first photoresist film PR1 remains, and portions exposed to the first resist opening PR1A and the second resist opening PR1B are selectively dissolved and removed by an etching solution. By this wet-etching, a first mask opening (third opening) MF1A overlapping the first resist opening PR1A and a second mask opening (fourth opening) MF1B overlapping the second resist opening PR1B are provided in the mask film MF1. Here, since the film thickness of the mask film MF1 is sufficiently smaller than the film thickness of the first photoresist film PR1, the opening edges of the first mask opening MF1A and the second mask opening MF1B are parallel (substantially parallel) to the normal line of the main surface of the glass substrate 21GS.

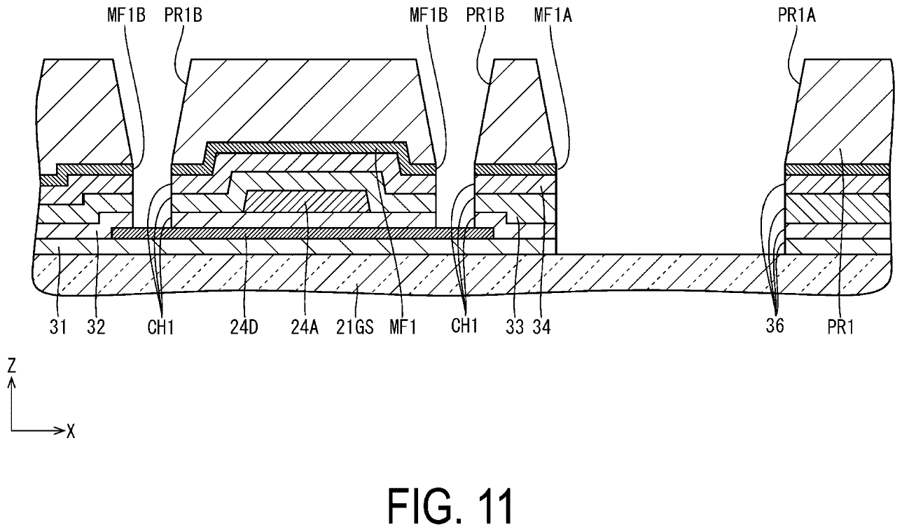

In the fifth step, the first interlayer insulating film 33, the second interlayer insulating film 34, the gate insulating film 32, and the base coat film 31 are sequentially dry-etched from the upper layer side using the mask film MF1 patterned as described above as a mask. Then, as illustrated in FIG. 11, the portions of the first interlayer insulating film 33, the second interlayer insulating film 34, the gate insulating film 32, and the base coat film 31 which overlap the first mask opening MF1A are removed, and the portions of the first interlayer insulating film 33, the second interlayer insulating film 34, and the gate insulating film 32 which overlap the second mask opening MF1B are removed. The portions of the first interlayer insulating film 33, the second interlayer insulating film 34, and the gate insulating film 32 which overlap the first photoresist film PR1 remain. The portion of the base coat film 31 which overlaps the first photoresist film PR1 and the second mask opening MF1B remains.

When the first interlayer insulating film 33, the second interlayer insulating film 34, the gate insulating film 32, and the base coat film 31 are selectively dry-etched through the first mask opening MF1A of the mask film MF1, as illustrated in FIG. 11, the first opening 36 overlapping the first mask opening MF1A is provided in the first interlayer insulating film 33, the second interlayer insulating film 34, the gate insulating film 32, and the base coat film 31 to communicate with each other. Here, as described above, the opening edge of the first mask opening MF1A in the mask film MF1 formed of a semiconductor material is parallel to the normal line of the main surface of the glass substrate 21GS. By dry-etching the first interlayer insulating film 33, the second interlayer insulating film 34, the gate insulating film 32, and the base coat film 31 using the mask film MF1 having such a configuration as a mask, it becomes easy to configure the opening edge of the first opening 36 along the normal line with respect to the main surface of the glass substrate 21GS. Accordingly, the portion of the glass substrate 21GS overlapping the first opening 36 is exposed. Similarly, when the first interlayer insulating film 33, the second interlayer insulating film 34, and the gate insulating film 32 are selectively dry-etched through the second mask opening MF1B of the mask film MF1, the first pixel contact hole CH1 overlapping the second mask opening MF1B is provided to communicate with the first interlayer insulating film 33, the second interlayer insulating film 34, and the gate insulating film 32. Accordingly, a portion of the semiconductor portion 24D which overlaps the first pixel contact hole CH1 is exposed. After the dry etching of the first interlayer insulating film 33, the second interlayer insulating film 34, the gate insulating film 32, and the base coat film 31 is completed in this manner, the first photoresist film PR1 is removed by a stripping solution. The first photoresist film PR1 can also be removed prior to the dry etching.

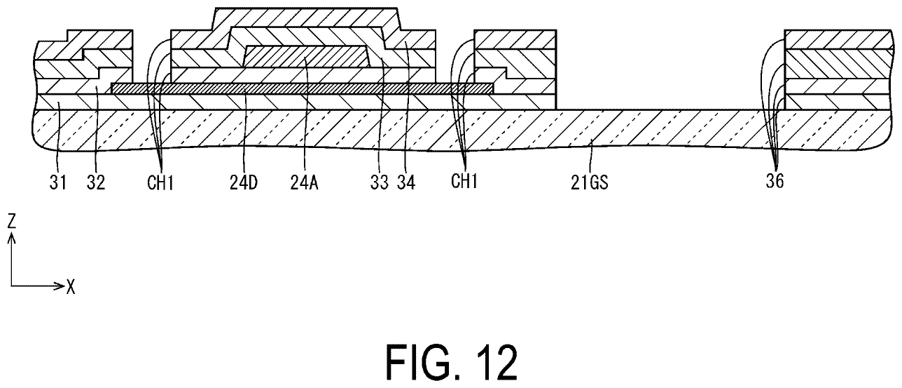

In the sixth step, as illustrated in FIG. 12, a cleaning agent containing, for example, hydrofluoric acid is supplied onto the mask film MF1. Then, the surface of the semiconductor portion 24D which is exposed through the first pixel contact hole CH1 is cleaned, and thus an oxide film formed on the surface of the semiconductor portion 24D is removed. At this time, the mask film MF1 is removed by being dissolved mainly by hydrofluoric acid. Since the mask film MF1 can be removed in the sixth step of cleaning the semiconductor portion 24D, the tact time can be shortened as compared with a case where a dedicated step for removing the mask film MF1 is required.

In the seventh step, the second metal film MF2 is formed on the second interlayer insulating film 34, and then a second photoresist film PR2 is formed on the second metal film MF2. Thereafter, the second photoresist film PR2 is exposed using an exposure device and a photomask having a predetermined opening pattern (the exposure device and the photomask are not illustrated in the drawing), and is then developed. Then, the second photoresist film PR2 remains on the second metal film MF2 in a form in which the opening pattern of the photomask is transferred. Specifically, when the second photoresist film PR2 is a positive type, an unexposed portion not overlapping the opening of the photomask remains, and when the second photoresist film PR2 is a negative type, an exposed portion overlapping the opening of the photomask remains. As illustrated in FIG. 13, the second photoresist film PR2 remains at a position where the source electrode 24B is to be formed, a position where the drain electrode 24C is to be formed, and a position where the source wiring line 27 is to be formed.

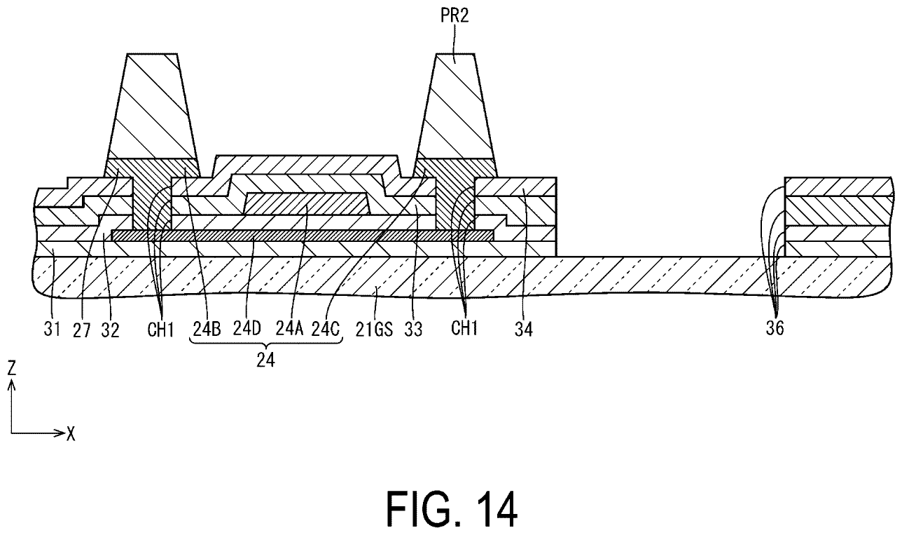

The second metal film MF2 is wet-etched or dry-etched using the second photoresist film PR2 having such a pattern as a mask. Then, as illustrated in FIG. 14, a portion of the second metal film MF2 which overlaps the second photoresist film PR2 selectively remains, and a portion of the second metal film MF2 which does not overlap the second photoresist film PR2 is selectively removed. Thereby, the source electrode 24B and the drain electrode 24C of the TFT 24 and the source wiring line 27 are formed (see FIGS. 4 and 5). The source electrode 24B is connected to the semiconductor portion 24D through one first pixel contact hole CH1. The drain electrode 24C is connected to the semiconductor portion 24D through the other first pixel contact hole CH1.

In the eighth step, the flattening film 35 is formed on the second interlayer insulating film 34 and the second metal film MF2, and the flattening film 35 is selectively etched by a photolithography method. Thereby, the second pixel contact hole CH2 is formed in the flattening film 35 at a position overlapping the drain electrode 24C (see FIG. 5). In the ninth step, a first transparent electrode film is formed on the flattening film 35, and the first transparent electrode film is selectively etched by a photolithography method. Thereby, the pixel electrode 25 is formed (see FIG. 5). The connection portion 25B of the pixel electrode 25 is connected to the drain electrode 24C through the second pixel contact hole CH2.

In the present embodiment, as illustrated in FIG. 11, in the fifth step, the first opening 36 is formed by etching the first interlayer insulating film 33, the second interlayer insulating film 34, the gate insulating film 32, and the base coat film 31 using the mask film MF1, which is formed of a semiconductor material, as a mask, and thus the opening edge of the first opening 36 can be easily configured to be along the normal line with respect to the main surface of the glass substrate 21GS. In this manner, the opening edge of the first opening 36 and the main body portion 25A of the pixel electrode 25 are in a non-overlapping relationship. Thereby, as compared with a case where an opening edge of an opening in a gate insulating film and an interlayer insulating film in the related art has a tapered shape inclined with respect to the normal line of a substrate, light directed toward the pixel electrode 25 is hardly reflected by the interface between the portions of the first interlayer insulating film 33 and the second interlayer insulating film 34 which configure the opening edge of the first opening 36, and external light is hardly reflected by the end face of the opening edge of the first opening 36. Moreover, in the present embodiment, since the first opening 36 is provided over the first interlayer insulating film 33, the second interlayer insulating film 34, the base coat film 31, and the gate insulating film 32, it is possible to avoid a situation in which unevenness occurs in the amount of light passing through the main body portion 25A of the pixel electrode 25 or color unevenness occurs, as compared with a case where the first opening is not formed in the base coat film 31 and the gate insulating film 32.

As described above, the array substrate (display substrate) 21 of the present embodiment includes the glass substrate (transparent substrate) 21GS having a light-transmitting property, the first interlayer insulating film (first insulating film) 33 disposed on the glass substrate 21GS, the second interlayer insulating film (second insulating film) 34 disposed on the first interlayer insulating film 33 and having a refractive index different from that of the first interlayer insulating film 33, and the pixel electrodes 25. The first interlayer insulating film 33 and the second interlayer insulating film 34 are each provided with the first opening 36 overlapping at least a part of the pixel electrode 25, and the opening edge of the first opening 36 is configured to be along the normal line (Z-axis direction) with respect to the main surface of the glass substrate 21GS.

Reflection of light may occur at the interface between the first interlayer insulating film 33 and the second interlayer insulating film 34 having different refractive indices. Since the first opening 36 overlapping at least a part of the pixel electrode 25 is provided in the first interlayer insulating film 33 and the second interlayer insulating film 34, a situation in which light directed toward the pixel electrode 25 is reflected at the interface between the first interlayer insulating film 33 and the second interlayer insulating film 34 is less likely to occur. In addition, since the opening edge of the first opening 36 is configured to be along the normal line with respect to the main surface of the glass substrate 21GS, an overlapping range between the opening edge of the first opening 36 and the pixel electrode 25 is narrowed or the opening edge of the first opening 36 and the pixel electrode 25 are in a non-overlapping relationship, as compared with a case where an opening edge of an opening in a gate insulating film and an interlayer insulating film in the related art has a tapered shape inclined with respect to the normal line of a substrate. Thereby, light directed toward the pixel electrode 25 is less likely to be reflected by the interface between the portions of the first interlayer insulating film 33 and the second interlayer insulating film 34 which configure the opening edge of the first opening 36, and external light is less likely to be reflected by the end face of the opening edge of the first opening 36.

The base coat film (third insulating film) 31 and the gate insulating film (third insulating film) 32 are provided above the glass substrate 21GS and under the first interlayer insulating film 33, and the first opening 36 is continuously provided in the base coat film 31 and the gate insulating film 32. The first opening 36 is continuously provided not only in the first interlayer insulating film 33 and the second interlayer insulating film 34 but also in the base coat film 31 and the gate insulating film 32 disposed above the glass substrate 21GS and under the first interlayer insulating film 33. When the first opening 36 is not formed in the base coat film 31 and the gate insulating film 32, there is a concern that portions of the base coat film 31 and the gate insulating film 32 which overlap the first opening 36 may be removed by etching when the first opening 36 is provided in the first interlayer insulating film 33 and the second interlayer insulating film 34, and in this case, there is a concern that a variation in film thickness of the portions of the base coat film 31 and the gate insulating film 32 which overlap the first opening 36 occurs, resulting in a concern that unevenness in the amount of transmitted light or color unevenness may occur. In this regard, the first opening 36 is provided over the first interlayer insulating film 33, the second interlayer insulating film 34, the base coat film 31, and the gate insulating film 32, and thus it is possible to avoid the occurrence of unevenness in the amount of transmitted light and color unevenness as described above. Moreover, since the opening edge of the first opening 36 is configured to be along the normal line with respect to the main surface of the glass substrate 21GS, light directed toward the pixel electrodes 25 is less likely to be reflected by the interface between the portions of the first interlayer insulating film 33, the second interlayer insulating film 34, the base coat film 31, and the gate insulating film 32 which configure the opening edge of the first opening 36, and external light is less likely to be reflected by the end face of the opening edge of the first opening 36.

The liquid crystal panel (display device) 11 according to the present embodiment includes the above-described array substrate 21 and the counter substrate 20 disposed to face the array substrate 21. According to the liquid crystal panel 11 having such a configuration, reflection of light at the opening edge of the first opening 36 is curbed, and thus a good display quality can be maintained.

The counter substrate 20 includes the black matrix (second light blocking portion) 29 that blocks light, and the black matrix 29 includes the pixel openings (second openings) 29A that overlap at least parts of the pixel electrode 25 and the first opening 36. An image can be displayed by using light that has passed through the first openings 36 and the pixel electrodes 25 and then through the pixel openings 29A of the black matrix 29.

A manufacturing method for the array substrate 21 of the present embodiment includes forming the first interlayer insulating film 33 on the glass substrate 21GS, forming the second interlayer insulating film 34 on the first interlayer insulating film 33, forming the mask film MF1, which is formed of a semiconductor material or a transparent electrode material, on the second interlayer insulating film 34, selectively etching the mask film MF1 to provide the first mask opening (third opening) MF1A, etching the first interlayer insulating film 33 and the second interlayer insulating film 34 through the first mask opening MF1A of the mask film MF1, providing the first opening 36 overlapping the first mask opening MF1A of the mask film MF1 in the first interlayer insulating film 33 and the second interlayer insulating film 34, and providing the pixel electrode 25 of which at least a part overlaps the first opening 36.

After the first interlayer insulating film 33, the second interlayer insulating film 34, and the mask film MF1 are sequentially formed on the glass substrate 21GS, the mask film MF1 is selectively etched to provide the first mask opening MF1A in the mask film MF1. Subsequently, when the first interlayer insulating film 33 and the second interlayer insulating film 34 are etched through the first mask opening MF1A of the mask film MF1, the first opening 36 overlapping the first mask opening MF1A of the mask film MF1 is provided in the first interlayer insulating film 33 and the second interlayer insulating film 34. Thereafter, the pixel electrode 25 of which at least a part overlaps the first opening 36 is provided. Since the first interlayer insulating film 33 and the second interlayer insulating film 34 are etched using the mask film MF1, which is formed of a semiconductor material or a transparent electrode material, as a mask, the opening edge of the first opening 36 can be easily configured to be along the normal line with respect to the main surface of the glass substrate 21GS. In this manner, as compared with a case where an opening edge of an opening in a gate insulating film and an interlayer insulating film in the related art has a tapered shape inclined with respect to the normal line of a substrate, an overlapping range between the opening edge of the first opening 36 and the pixel electrode 25 is narrowed or the opening edge of the first opening 36 and the pixel electrode 25 are in a non-overlapping relationship. Thereby, light directed toward the pixel electrode 25 is less likely to be reflected by the interface between the portions of the first interlayer insulating film 33 and the second interlayer insulating film 34 which configure the opening edge of the first opening 36, and external light is less likely to be reflected by the end face of the opening edge of the first opening 36.

Before the first interlayer insulating film 33 is formed, the semiconductor film is formed on the glass substrate 21GS, the semiconductor portion 24D is provided by selectively etching the semiconductor film, the mask film MF1 is selectively etched to provide the second mask opening (fourth opening) MF1B overlapping a part of the semiconductor portion 24D together with the first mask opening MF1A, the first interlayer insulating film 33 and the second interlayer insulating film 34 are etched through the first mask opening MF1A and the second mask opening MF1B of the mask film MF1, the first pixel contact hole (fifth opening) CH1 overlapping the second mask opening MF1B of the mask film MF1 together with the first opening 36 is provided in the first interlayer insulating film 33 and the second interlayer insulating film 34, the first interlayer insulating film 33 and the second interlayer insulating film 34 are etched, and then a cleaning agent containing hydrofluoric acid is supplied onto the mask film MF1, thereby cleaning, through the first pixel contact hole CH1, a portion of the semiconductor portion 24D which faces the first pixel contact hole CH1 and removing the mask film MF1. The semiconductor portion 24D is provided by selectively etching the semiconductor film formed on the glass substrate 21GS. By selectively etching the mask film MF1, the second mask opening MF1B is provided together with the first mask opening MF1A in the mask film MF1. Subsequently, when the first interlayer insulating film 33 and the second interlayer insulating film 34 are etched through the first mask opening MF1A and the second mask opening MF1B of the mask film MF1, the first pixel contact hole CH1 overlapping the second mask opening MF1B of the mask film MF1 is provided together with the first opening 36 in the first interlayer insulating film 33 and the second interlayer insulating film 34. The semiconductor portion 24D is partially exposed through the first pixel contact hole CH1 of the first interlayer insulating film 33 and the second interlayer insulating film 34. In this state, when a cleaning agent containing hydrofluoric acid is supplied onto the mask film MF1, a portion of the semiconductor portion 24D which faces the first pixel contact hole CH1 is cleaned through the first pixel contact hole CH1. At this time, the mask film MF1, which is formed of a semiconductor material or a transparent electrode material, is dissolved by the cleaning agent, and as a result, the mask film MF1 is removed. Since the mask film MF1 can be removed in the step of cleaning the semiconductor portion 24D, the tact time can be shortened as compared with a case where a dedicated step for removing the mask film MF1 is required.

The mask film MF1 is wet-etched to provide the first mask opening MF1A, and the first interlayer insulating film 33 and the second interlayer insulating film 34 are dry-etched through the first mask opening MF1A of the mask film MF1 to provide the first opening 36. The mask film MF1, which is formed of a semiconductor material or a transparent electrode material, is wet-etched to provide the first mask opening MF1A in the mask film MF1. By dry-etching the first interlayer insulating film 33 and the second interlayer insulating film 34 through the first mask opening MF1A of the mask film MF1, the first opening 36 having an opening edge configured to be along the normal line with respect to the main surface of the glass substrate 21GS can be easily provided.

Before the first interlayer insulating film 33 is formed on the glass substrate 21GS, the base coat film 31 and the gate insulating film 32 are formed, the base coat film 31 and the gate insulating film 32 are etched in addition to the first interlayer insulating film 33 and the second interlayer insulating film 34 through the first mask opening MF1A of the mask film MF1, and the first opening 36 is provided continuously over the first interlayer insulating film 33, the second interlayer insulating film 34, the base coat film 31, and the gate insulating film 32. When the base coat film 31 and the gate insulating film 32 are etched in addition to the first interlayer insulating film 33 and the second interlayer insulating film 34 through the first mask opening MF1A of the mask film MF1, the first opening 36 is provided continuously over the first interlayer insulating film 33, the second interlayer insulating film 34, the base coat film 31, and the gate insulating film 32. When the first opening 36 is not formed in the base coat film 31 and the gate insulating film 32, there is a concern that portions of the base coat film 31 and the gate insulating film 32 which overlap the first opening 36 may be removed by etching when the first opening 36 is provided in the first interlayer insulating film 33 and the second interlayer insulating film 34, and in this case, there is a concern that a variation in film thickness of the portions of the base coat film 31 and the gate insulating film 32 which overlap the first opening 36 occurs, resulting in a concern that unevenness in the amount of transmitted light or color unevenness may occur. In this regard, the first opening 36 is provided over the first interlayer insulating film 33, the second interlayer insulating film 34, the base coat film 31, and the gate insulating film 32, and thus it is possible to avoid the occurrence of unevenness in the amount of transmitted light and color unevenness as described above. Moreover, since the opening edge of the first opening 36 is configured to be along the normal line with respect to the main surface of the glass substrate 21GS, light directed toward the pixel electrodes 25 is less likely to be reflected by the interface between the portions of the first interlayer insulating film 33, the second interlayer insulating film 34, the base coat film 31, and the gate insulating film 32 which configure the opening edge of the first opening 36, and external light is less likely to be reflected by the end face of the opening edge of the first opening 36.

### Second Embodiment

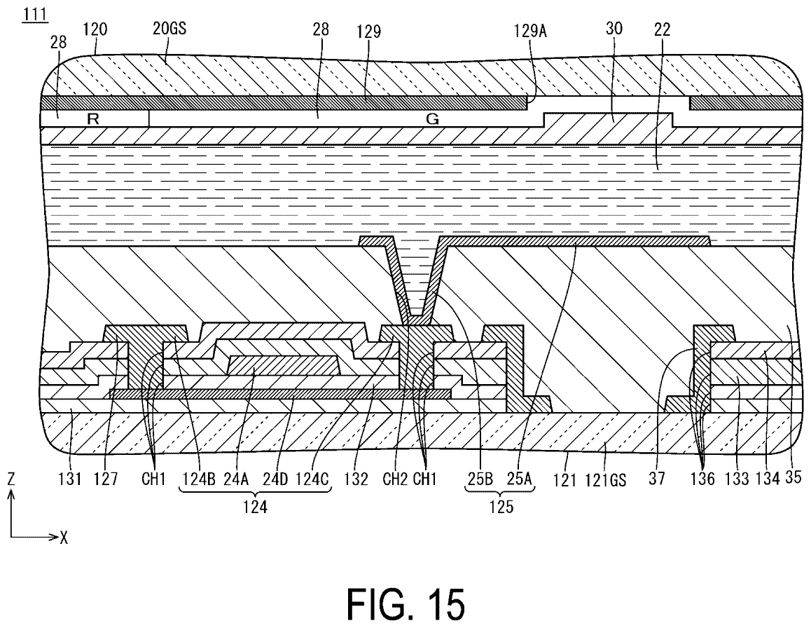

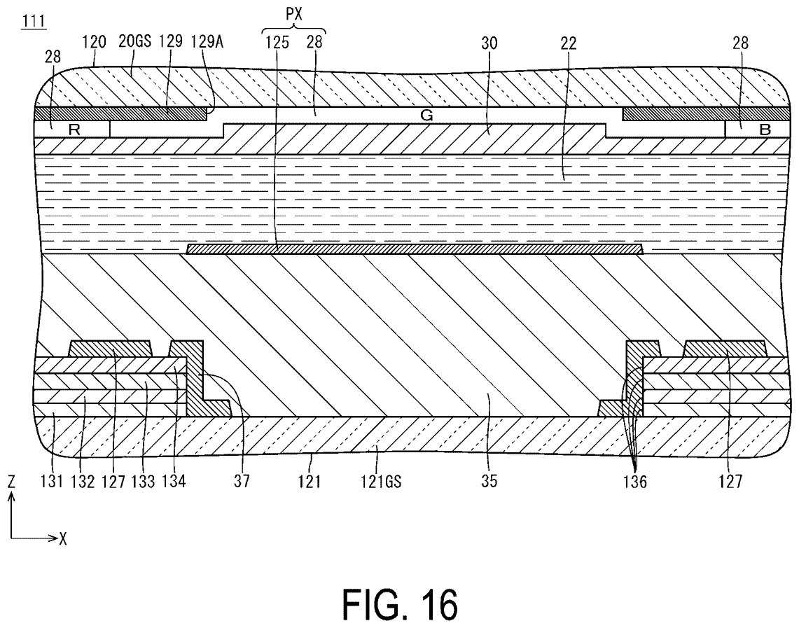

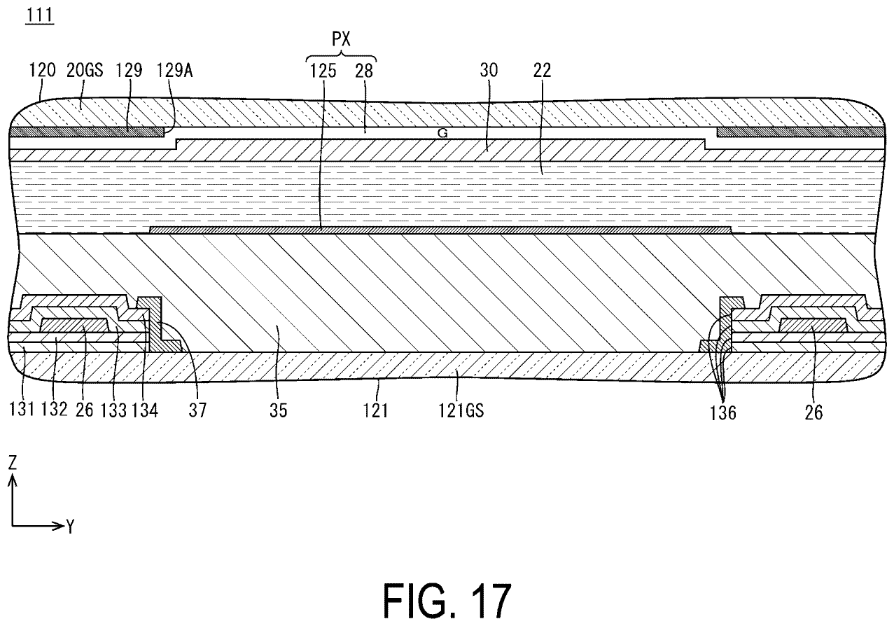

A second embodiment will be described with reference to FIGS. 15 to 19. In the second embodiment, a case is described in which a first light blocking portion 37 that covers an opening edge of a first opening 136 is added. Further, repetitive descriptions of structures, actions, and effects similar to those of the first embodiment described above will be omitted.

As illustrated in FIGS. 15 to 17, an array substrate 121 according to the present embodiment is provided with the first light blocking portion 37 that covers the opening edge of the first opening 136 in a first interlayer insulating film 133, a second interlayer insulating film 134, a gate insulating film 132, and a base coat film 131. The first light blocking portion 37 is formed of a light blocking material that blocks light, and is configured with, for example, a part of a second metal film MF102. Thus, the first light blocking portion 37 has at least a portion disposed on the side of a layer higher than the second interlayer insulating film 134. The first light blocking portion 37 has an annular shape extending over the entire circumference of the first opening 136 in a plan view. The first light blocking portion 37 is disposed across an end face of the opening edge of the first opening 136 from the inner circumference side to the outer circumference side thereof. Thus, the first light blocking portion 37 covers the entire end face of the opening edge of the first opening 136, covers the entire circumference of the second interlayer insulating film 134 at the opening edge of the first opening 136, and covers the entire circumference of a portion adjacent to the first opening 136 on the surface of a glass substrate 121GS.

According to such a configuration, the first light blocking portion 37 can block light directed toward the opening edge of the first opening 136 in the first interlayer insulating film 133, the second interlayer insulating film 134, the gate insulating film 132, and the base coat film 131. Thereby, it is possible to further curb the generation of reflected light at an interface between portions of the first interlayer insulating film 133, the second interlayer insulating film 134, the gate insulating film 132, and the base coat film 131 which configure the opening edge of the first opening 136 and the generation of reflected light at an end face of the opening edge of the first opening 136. Moreover, since the first light blocking portion 37 is configured with a part of the second metal film MF102 which is the same as a source electrode 124B and a drain electrode 124C, it is possible to achieve a reduction in manufacturing cost, and the like as compared with a case where a dedicated light blocking film is provided to provide the first light blocking portion 37.

The present embodiment has the above-described structure, and subsequently, an array substrate manufacturing step included in a manufacturing method for the liquid crystal panel 111 will be mainly described. A seventh step will be described in detail below. First to sixth steps, an eighth step, and a ninth step are as described in the first embodiment.

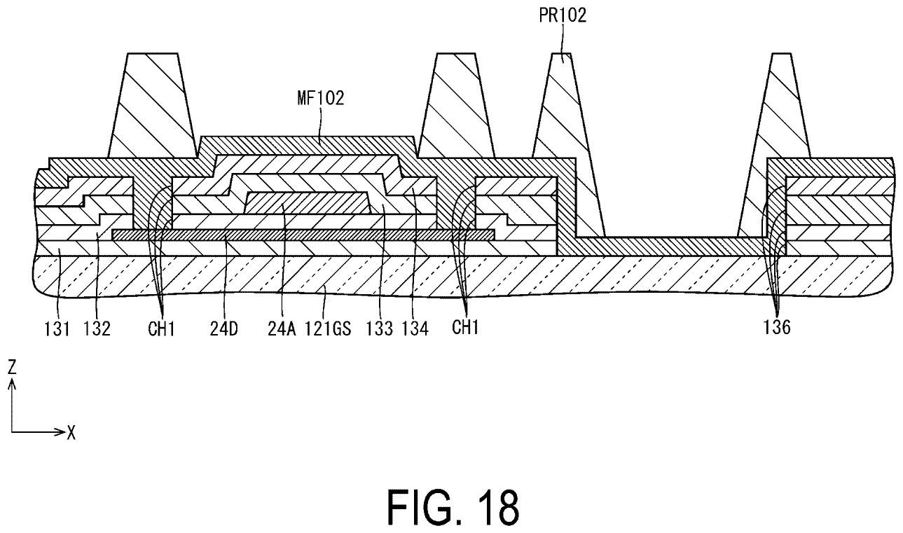

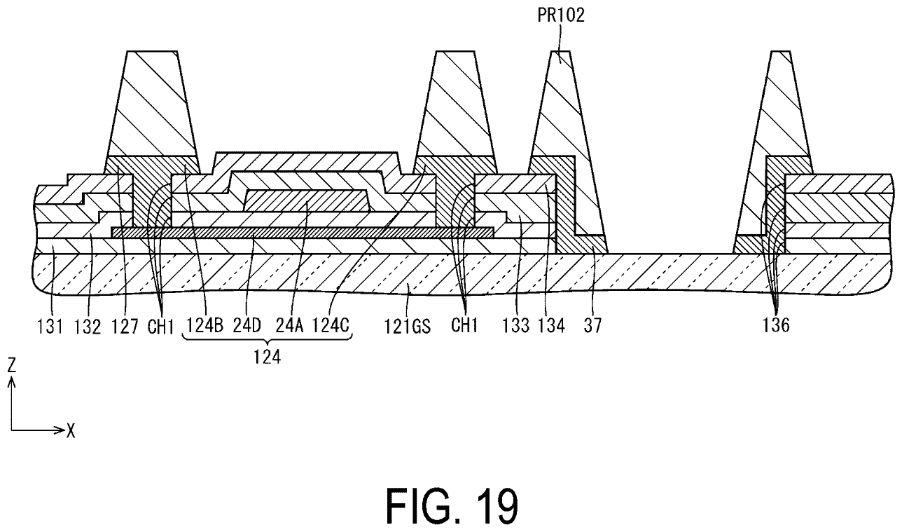

When a second photoresist film PR102 formed on the second metal film MF102 is exposed and developed in the seventh step, the second photoresist film PR102 having a pattern as illustrated in FIG. 18 remains. The second photoresist film PR102 remains at a position where the first light blocking portion 37 is to be formed, in addition to a position where the source electrode 124B is to be formed, a position where the drain electrode 124C is to be formed, and a position where a source wiring line 127 is to be formed (see FIG. 15). The second metal film MF102 is wet-etched or dry-etched using the second photoresist film PR102 having such a configuration as a mask. Then, as illustrated in FIG. 19, a portion of the second metal film MF102 which overlaps the second photoresist film PR102 selectively remains, and a portion of the second metal film MF102 which does not overlap the second photoresist film PR102 is selectively removed. Thereby, the first light blocking portion 37 is formed in addition to the source electrode 124B and the drain electrode 124C of a TFT 124 and the source wiring line 127. The opening edge of the first opening 136 in the first interlayer insulating film 133, the second interlayer insulating film 134, the gate insulating film 132, and the base coat film 131 is covered with the first light blocking portion 37.

In a bonding step included in the manufacturing method for the liquid crystal panel 111, when a counter substrate 120 and an array substrate 121 are bonded together, the counter substrate 120 may be slightly offset with respect to the array substrate 121 in a direction along the main surface (horizontal direction). In this case, there is a concern that the first opening 136 on the array substrate 121 side and a pixel opening 129A on the counter substrate 120 side may be disposed misaligned. Even in such a case, as illustrated in FIGS. 15 to 17, since the opening edge of the first opening 136 is covered with the first light blocking portion 37, the generation of reflected light at an interface between the portions the first interlayer insulating film 133, the second interlayer insulating film 134, the gate insulating film 132, and the base coat film 131 which configure the opening edge of the first opening 136 or the generation of reflected light at an end face of the opening edge of the first opening 136 is curbed. Thereby, even when the first opening 136 and the pixel opening 129A are disposed misaligned, unnecessary reflected light is less likely to pass through the pixel opening 129A, and the display quality is more reliably maintained.

As described above, the array substrate 121 according to the present embodiment includes the first light blocking portion 37 that covers the opening edge of the first opening 136 in the first interlayer insulating film 133 and the second interlayer insulating film 134 and blocks light. The first light blocking portion 37 can block light directed toward the opening edge of the first opening 136 in the first interlayer insulating film 133 and the second interlayer insulating film 134. Thereby, it is possible to further curb the generation of reflected light at an interface between portions of the first interlayer insulating film 133 and the second interlayer insulating film 134 which configure the opening edge of the first opening 136 and the generation of reflected light at an end face of the opening edge of the first opening 136.

The source electrode (electrode) 124B and the drain electrode (electrode) 124C which are configured with a part of the second metal film (metal film) MF102 disposed on the second interlayer insulating film 134 are provided, and the first light blocking portion 37 is configured with a part of the second metal film MF102. Since the source electrode 124B, the drain electrode 124C, and the first light blocking portion 37 are configured with respective parts of the second metal film MF102, it is possible to achieve a reduction in manufacturing cost, and the like as compared with a case where a dedicated light blocking film is provided to provide the first light blocking portion 37.

The liquid crystal panel 111 of the present embodiment includes the array substrate 121 described above and the counter substrate 120 disposed to face the array substrate 121, the counter substrate 120 includes a black matrix 129 that blocks light, and the black matrix 129 includes pixel openings 129A overlapping at least parts of the pixel electrode 125 and the first opening 136. An image can be displayed by using light that has passed through the first openings 136 and the pixel electrodes 125 and then through the pixel openings 129A of the black matrix 129. When the array substrate 121 includes the first light blocking portion 37, even when positional offset occurs between the array substrate 121 and the counter substrate 120 and the first opening 136 and the pixel opening 129A are disposed misaligned, the opening edge of the first opening 136 is covered with the first light blocking portion 37, and thus the generation of reflected light at an interface between the portions the first interlayer insulating film 133 and the second interlayer insulating film 134 which configure the opening edge of the first opening 136 or the generation of reflected light at an end face of the opening edge of the first opening 136 is curbed. This increases the reliability of maintaining good display quality.

As described above, in the manufacturing method for the array substrate 121 according to the present embodiment, after the first opening 136 is provided in the first interlayer insulating film 133 and the second interlayer insulating film 134, the second metal film (metal film) MF102 is formed on the second interlayer insulating film 134, and the second metal film MF102 is selectively etched to provide the first light blocking portion 37 covering the opening edge of the first opening 136. The first light blocking portion 37 covering the opening edge of the first opening 136 is provided by selectively etching the second metal film MF102 formed on the second interlayer insulating film 134. The first light blocking portion 37 can block light directed toward the opening edge of the first opening 136 in the first interlayer insulating film 133 and the second interlayer insulating film 134. Thereby, it is possible to further curb the generation of reflected light at an interface between portions of the first interlayer insulating film 133 and the second interlayer insulating film 134 which configure the opening edge of the first opening 136 and the generation of reflected light at an end face of the opening edge of the first opening 136.

The source electrode (electrode) 124B and the drain electrode (electrode) 124C are provided together with the first light blocking portion 37 by selectively etching the second metal film MF102. The source electrode 124B, the drain electrode 124C, and the first light blocking portion 37 are provided by selectively etching the second metal film MF102. In this manner, since the source electrode 124B, the drain electrode 124C, and the first light blocking portion 37 are configured with respective parts of the second metal film MF102, it is possible to achieve a reduction in manufacturing cost, and the like as compared with a case where a dedicated light blocking film is provided to provide the first light blocking portion 37.

### Other Embodiments

The technology disclosed in the present specification is not limited to the embodiments described above and illustrated in the drawings, and the following embodiments, for example, are also included within the technical scope.
(1) The material of the mask film MF1 may be an amorphous silicon material other than an oxide semiconductor material.
(2) The material of the mask film MF1 may be a transparent electrode material (ITO, IZO, or the like) other than a semiconductor material.
(3) The first opening 36, 136 may be formed in the gate insulating film 32, 132, the first interlayer insulating film 33, 133, and the second interlayer insulating film 34, 134, but may not be formed in the base coat film 31, 131. The first opening 36, 136 may be formed in the first interlayer insulating film 33, 133 and the second interlayer insulating film 34, 134, but may not be formed in the base coat film 31, 131 and the gate insulating film 32, 132.
(4) The array substrate 21, 121 may be additionally provided with an insulating film formed of an inorganic material on the side of a layer lower than the flattening film 35 and on the side of a layer higher than the second metal film MF2, MF102.
(5) In the above (4), the array substrate 21, 121 may be additionally provided with a metal film or a transparent electrode film on the side of a layer higher than the added insulating film and on the side of a layer lower than the flattening film 35. In this case, the added metal film or transparent electrode film may be patterned to provide relay electrodes overlapping both the drain electrode 24C, 124C and the connection portion 25B, contact holes overlapping the relay electrodes may be provided in the added insulating film and the flattening film, respectively, and the relay electrodes may be connected to the drain electrode 24C, 124C and the connection portion 25B through the contact holes.
(6) The flattening film 35 may not be formed on the array substrate 21, 121. In this case, an insulating film formed of an inorganic material may also be provided instead of the flattening film 35.
(7) Specific materials used for the first interlayer insulating film 33, 133 and the second interlayer insulating film 34, 134 may be changed as appropriate other than the above.
(8) The pixel electrode 25, 125 may be disposed on the side of a layer lower than the first interlayer insulating film 33, 133 in the array substrate 21, 121. In this case, for example, a part of the semiconductor film may be made to have a low resistance (to be conductive), and the low resistance part may be used as the pixel electrode 25, 125.
(9) The drain electrode 24C, 124C may be provided such that a portion overlapping the semiconductor portion 24D and a portion overlapping the connection portion 25B do not overlap each other. In this case, the second pixel contact hole CH2 connecting the drain electrode 24C, 124C and the connection portion 25B is disposed not to overlap the other first pixel contact hole CH1 connecting the drain electrode 24C, 124C and the semiconductor portion 24D.
(10) The TFT 24, 124 may be of a double gate type or the like other than a top gate type. In this case, for example, a metal film is formed on the side of a layer lower than the base coat film 31, 131, and bottom gate electrodes overlapping the semiconductor portion 24D may be provided using the metal film.
(11) The material of the semiconductor film may be an oxide semiconductor material or an amorphous silicon semiconductor material. In this case, the array substrate 21, 121 has a film composition in which the first metal film, the gate insulating film 32, 132, the semiconductor film, the first interlayer insulating film 33, 133, the second interlayer insulating film 34, 134, the second metal film MF2, MF102, the flattening film 35, and the first transparent electrode film are layered in this order on the glass substrate 21GS, 121GS, and the base coat film 31, 131 is omitted. In such a configuration, the first opening 36, 136 may be provided to penetrate the gate insulating film 32, 132, the first interlayer insulating film 33, 133, and the second interlayer insulating film 34, 134, but may not be formed in the gate insulating film 32, 132.
(12) In the above (11), the TFT 24, 124 may be of a bottom gate type or a double gate type.
(13) In the non-display region NAA of the array substrate 21, 121, a gate drive circuit (gate driver monolithic (GDM) circuit) for supplying scanning signals to the gate wiring lines 26 and a switch circuit (source shared driving (SSD) circuit) for distributing image signals supplied from the driver 12 to the plurality of source wiring lines 27 may be provided monolithically using the films on the glass substrate 21GS, 121GS.
(14) In the above (13), the array substrate 21, 121 may be provided with a first semiconductor film formed of a polysilicon semiconductor material and a second semiconductor film formed of an oxide semiconductor material or an amorphous silicon semiconductor material. In this case, the first semiconductor film may configure the semiconductor portion of the transistor configuring the gate drive circuit and the switch circuit disposed in the non-display region NAA, and the second semiconductor film may configure the semiconductor portion 24D of the TFT 24, 124 disposed in the display region AA.
(15) The black matrix 29, 129 may be provided on the array substrate 21, 121.
(16) The array substrate 21, 121 may include a resin substrate formed of a synthetic resin as a transparent substrate, in addition to the glass substrate 21GS, 121GS.
(17) The driver 12 may be mounted by chip on film (COF) on the flexible substrate 13, which is mounted by film on glass (FOG) on the array substrate 21, 121.
(18) The planar shape of the liquid crystal panel 11, 111 may be a vertically elongated rectangle, a square, a circle, a semicircle, a vertically elongated oval, an ellipse, a trapezoid, or the like.
(19) The display mode of the liquid crystal panel 11, 111 may be any of a fringe field switching (FFS) mode, a twisted nematic (TN) mode, a vertical alignment (VA) mode, an in-plane switching (IPS) mode, and the like.
(20) The display device may be an organic electroluminescence (EL) display panel or a microcapsule-type electrophoretic display panel (EPD), other than the liquid crystal panel 11, 111.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display substrate comprising:
a transparent substrate having a light-transmitting property;
a first insulating film disposed on the transparent substrate;
a second insulating film disposed on the first insulating film and having a refractive index different from a refractive index of the first insulating film; and
a pixel electrode,
wherein the first insulating film and the second insulating film are provided with a first opening overlapping at least a part of the pixel electrode, and an opening edge of the first opening is configured to be along a normal line with respect to a main surface of the transparent substrate.

2. The display substrate according to claim 1, further comprising:
a third insulating film disposed above the transparent substrate and below the first insulating film,
wherein the first opening is continuously provided in the third insulating film.

3. The display substrate according to claim 1, further comprising:
a first light blocking portion configured to cover the opening edge of the first opening in the first insulating film and the second insulating film and block light.

4. The display substrate according to claim 3, further comprising:
an electrode configured with a part of a metal film disposed on the second insulating film,
wherein the first light blocking portion is configured with a part of the metal film.

5. A display device comprising:
the display substrate according to claim 1; and
a counter substrate disposed facing the display substrate.

6. The display device according to claim 5,
wherein the counter substrate includes a second light blocking portion configured to block light, and
the second light blocking portion includes a second opening overlapping at least a part of the pixel electrode and at least a part of the first opening.

7. A manufacturing method for a display substrate, the manufacturing method comprising:
forming a first insulating film on a transparent substrate;
forming a second insulating film on the first insulating film;
forming a mask film formed of a semiconductor material or a transparent electrode material on the second insulating film;
selectively etching the mask film to provide a third opening;
etching the first insulating film and the second insulating film through the third opening of the mask film to provide a first opening in the first insulating film and the second insulating film, the first opening overlapping the third opening of the mask film; and
providing a pixel electrode of which at least a part overlaps the first opening.

8. The manufacturing method for the display substrate according to claim 7, further comprising:
forming a semiconductor film on the transparent substrate before forming the first insulating film;
selectively etching the semiconductor film to provide a semiconductor portion;
selectively etching the mask film to provide a fourth opening overlapping a part of the semiconductor portion together with the third opening;
etching the first insulating film and the second insulating film through the third opening and the fourth opening of the mask film to provide a fifth opening in the first insulating film and the second insulating film, the fifth opening overlapping the fourth opening of the mask film together with the first opening;
etching the first insulating film and the second insulating film and then supplying a cleaning agent containing hydrofluoric acid onto the mask film to clean, through the fifth opening, a portion of the semiconductor portion which faces the fifth opening and remove the mask film.

9. The manufacturing method for the display substrate according to claim 7, further comprising:
wet-etching the mask film to provide the third opening; and
dry-etching the first insulating film and the second insulating film through the third opening of the mask film to provide the first opening.

10. The manufacturing method for the display substrate according to claim 7, further comprising:
forming a third insulating film before forming the first insulating film on the transparent substrate; and
etching the third insulating film in addition to the first insulating film and the second insulating film through the third opening of the mask film such that the first opening is provided continuously over the first insulating film, the second insulating film, and the third insulating film.

11. The manufacturing method for the display substrate according to claim 7, further comprising:
forming a metal film on the second insulating film after providing the first opening in the first insulating film and the second insulating film; and
selectively etching the metal film to provide a first light blocking portion covering the opening edge of the first opening.

12. The manufacturing method for the display substrate according to claim 11, further comprising:
selectively etching the metal film to provide an electrode together with the first light blocking portion.
